(19) United States
(12) Patent Application Publication
(10) Pub. No.: US 2023/0008842 A1
(43) Pub. Date: Jan. 12, 2023

(54) PROJECTION SYSTEM AND METHOD WITH MODULAR PROJECTION LENS

(71) Applicant: Dolby Laboratories Licensing Corporation, San Francisco, CA (US)

(72) Inventors: Duane Scott Dewald, Dallas, TX (US); John David JACKSON, Allen, TX (US); Darren HENNIGAN, Prosper, TX (US)

(73) Assignee: Dolby Laboratories Licensing Corporation, San Francisco, CA (US)

(21) Appl. No.: 17/780,452

(22) PCT Filed: Dec. 3, 2020
(86) PCT No.: PCT/US2020/063169

§ 371 Date: May 26, 2022

Related U.S. Application Data
(60) Provisional application No. 62/944,931, filed on Dec. 6, 2019.
(60) Provisional application No. 63/047,456, filed on Jul. 2, 2020.

(51) Int. Cl. G02B 15/14; G02B 13/16; G02B 7/02

(52) U.S. Cl. CPC G02B 15/14; G02B 13/16; G02B 7/028

(57) ABSTRACT

A projection lens system and method therefor relate to a Fourier lens assembly including a first attachment section, the Fourier lens assembly configured to form a Fourier transform of an object at an exit pupil of the Fourier lens assembly; an aperture configured to block a portion of 5 incident light, the aperture located approximately at a plane of the Fourier transform; and a zoom lens assembly including a second attachment section configured to be removably attached to the first attachment section.

### CROSS-REFERENCE TO RELATED APPLICATIONS

This application claims priority to United States Provisional Patent Application No. 62/944,931 filed 6 Dec. 2019 and U.S. Provisional Patent Application No. 63/047,456 filed 2 Jul. 2020, which are incorporated herein by reference.

### BACKGROUND

### 1. Field of the Disclosure

This application relates generally to projection systems and methods of driving a projection system.

### 2. Description of Related Art

Digital projection systems typically utilize a light source and an optical system to project an image onto a surface or screen. The optical system includes components such as mirrors, lenses, waveguides, optical fibers, beam splitters, diffusers, spatial light modulators (SLMs), and the like. The contrast of a projector indicates the brightest output of the projector relative to the darkest output of the projector. Contrast ratio is a quantifiable measure of contrast, defined as a ratio of the luminance of the projector's brightest output to the luminance of the projector's darkest output. This definition of contrast ratio is also referred to as “static,” “native,” or “sequential” contrast ratio.

Some projection systems are based on SLMs that implement a spatial amplitude modulation, such as a digital micromirror device (DMD) chip. Where a DMD chip is used as a light modulator, a projection display may use the diffraction effect of the DMD to create high contrast ratios. The contrast ratio in such systems may be based on various parameters, such as the particular combination of DMD pixel size, tilt angle, illumination angle, and illumination f/#. Other relevant factors in the design of the projection system include the projection lens, where a Fourier filter (aperture) is to be placed. The Fourier aperture blocks diffraction orders in the projection lens that may reduce the contrast of the image.

### BRIEF SUMMARY OF THE DISCLOSURE

Various aspects of the present disclosure relate to devices, systems, and methods for projection display using a high-contrast projection architecture.

In one exemplary aspect of the present disclosure, there is provided a projection lens system, comprising: a Fourier lens assembly including a first attachment section, the Fourier lens assembly configured to form a Fourier transform of an object at an exit pupil of the Fourier lens assembly; an aperture configured to block a portion of incident light, the aperture located approximately at a plane of the Fourier transform; and a zoom lens assembly including a second attachment section configured to be removably attached to the first attachment section.

In another exemplary aspect of the present disclosure, there is provided a method of providing a projection lens system, comprising: providing a Fourier lens assembly including a first attachment section, the Fourier lens assembly configured to form a Fourier transform of an object at an exit pupil of the Fourier lens assembly; disposing an aperture approximately at the a plane of the Fourier transform, the aperture configured to block a portion of incident light; providing a first zoom lens assembly including a second attachment section; and removably attaching the second attachment section to the first attachment section.

In this manner, various aspects of the present disclosure provide for the display of images having a high dynamic range, high contrast ratio, and high resolution, and effect improvements in at least the technical fields of image projection, holography, signal processing, and the like.

### DESCRIPTION OF THE DRAWINGS

These and other more detailed and specific features of various embodiments are more fully disclosed in the following description, reference being had to the accompanying drawings, in which:

FIG. 1 illustrates a block diagram of an exemplary projection system according to various aspects of the present disclosure;

FIG. 2 illustrates an exemplary projection lens system according to various aspects of the present disclosure;

FIG. 3 illustrates an exemplary lens configuration of a portion of the exemplary projection lens system of FIG. 2;

FIG. 4 illustrates an exemplary lens configuration of another portion of the exemplary projection lens system of FIG. 2;

FIG. 5 illustrates an exemplary assembled lens configuration of the exemplary projection lens system of FIG. 2; and

FIGS. 6A-B illustrates exemplary methods of providing projection lens systems in accordance with various aspects of the present disclosure.

### DETAILED DESCRIPTION

This disclosure and aspects thereof can be embodied in various forms, including hardware, devices, or circuits controlled by computer-implemented methods, computer program products, computer systems and networks, user interfaces, and application programming interfaces; as well as hardware-implemented methods, signal processing circuits, memory arrays, application specific integrated circuits (ASICs), field programmable gate arrays (FPGAs), and the like. The foregoing summary is intended solely to give a general idea of various aspects of the present disclosure, and does not limit the scope of the disclosure in any way.

In the following description, numerous details are set forth, such as optical device configurations, timings, operations, and the like, in order to provide an understanding of one or more aspects of the present disclosure. It will be readily apparent to one skilled in the art that these specific details are merely exemplary and not intended to limit the scope of this application.

Moreover, while the present disclosure focuses mainly on examples in which the various circuits are used in digital projection systems, it will be understood that this is merely one example of an implementation. It will further be understood that the disclosed systems and methods can be used in any device in which there is a need to project light; for example, cinema, consumer and other commercial projection systems, heads-up displays, virtual reality displays, and the like.

### Projector Systems

In cinema applications, a projection system projects images onto a screen in a theater for viewing by audience members seated in the theater. Different theaters have different physical parameters (e.g., room size, screen size, screen-to-projector distance, lighting, and so on). To adapt to various theaters, a range of focal length projection zoom systems are available. In some projection zoom lens systems, the Fourier plane (that is, a plane at which a Fourier transform of an object is formed) cannot be reached, as it is embedded in the lens assembly. In some cases, the Fourier plane is actually in an optical element of the projection zoom lens system, and in different projection zoom lens systems the Fourier plane may be in a different place with a different focal length. As a result, the appropriate Fourier aperture is different for each focal length, leading to the potential need for many different aperture sizes tailored to each lens system.

Projectors or other display systems including or relating to a Fourier plane and aperture have been described in commonly-owned patents and patent applications, including WIPO Pub. No. 2019/195182, titled “Systems and Methods for Digital Laser Projection with Increased Contrast Using Fourier Filter,” the contents of which are herein incorporated by reference in their entirety. In comparative example projection zoom lens systems which are not modular in nature, one cannot access the Fourier plane to replace or swap out the Fourier aperture. Moreover, in such comparative example systems, one cannot adapt to a full range of theater parameters without replacing the projection zoom lens system in its entirety.

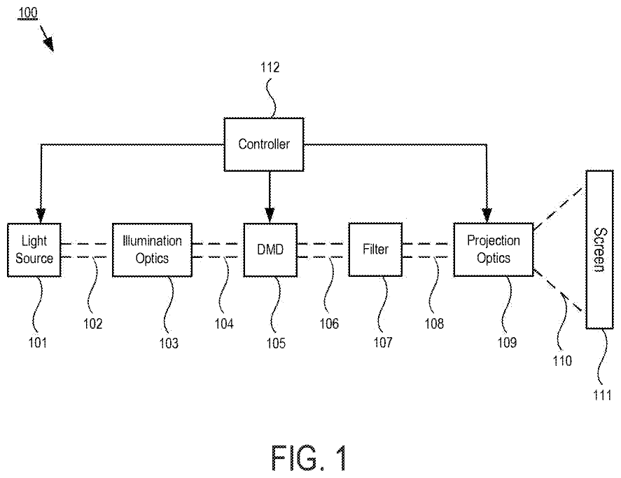

In order to allow access to the Fourier plane and provide the ability to adapt to a full range of theaters, a projection system including a modular projection zoom lens system may be provided. FIG. 1 illustrates an exemplary high contrast projection system 100 according to various aspects of the present disclosure. In particular, FIG. 1 illustrates a projection system 100 which includes a light source 101 configured to emit a first light 102; illumination optics 103 configured to receive the first light 102 and redirect or otherwise modify it, thereby to generate a second light 104; a DMD 105 configured to receive the second light 104 and selectively redirect and/or modulate it as a third light 106; a filter 107 configured to filter the third light 106, thereby to generate a fourth light 108; and projection optics 109 (an example of a projection lens system according to various aspects of the present disclosure) configured to receive the fourth light 108 and project it as a fifth light 110 onto a screen 111. Various elements of the projection system 100 may be operated by or under the control of a controller 112; for example, one or more processors such as a central processing unit (CPU) of the projection system 100.

In 3D projection implementations, a physical projector may include two projection systems 100 disposed side-by-side, with each individual projection system 100 projecting an image corresponding to one eye of the viewer. Alternatively, a physical projector may utilize one combined projection system 100 to project individual images corresponding to both eyes of the viewer.

The DMD 105 may include a plurality of reflective elements (micromirrors or simply “mirrors”) arranged in, for example, a two-dimensional array. In some examples, the resolution of the DMD 105 (i.e., the number of reflective elements) may be 2K (2048×1080), 4K (4096×2160), 1080p (1920×1080), consumer 4K (3840×2160), and the like. Individual reflective elements receive portions of the second light 104 from the illumination optics 103 and selective convey light to the projection optics 109 via the filter 107. Thus, the reflective elements may be formed of or coated with any highly reflective material, such as aluminum or silver, to thereby specularly reflect light. Moreover, to appropriately convey light, the individual reflective elements may be configured to switch between an on position in which light is reflected to the filter 107 and an off position in which light is reflected to a light dump. Such switching may be performed under the control of the controller 112.

In practical implementations, the projection system 100 may include fewer optical components or may include additional optical components such as mirrors, lenses, waveguides, optical fibers, beam splitters, diffusers, and the like. With the exception of the screen 111, the components illustrated in FIG. 1 may be integrated into a housing to provide a projection device. Such a projection device may include additional components such as a memory, input/output ports, communication circuitry, a power supply, and the like.

The light source 101 may be, for example, a laser light source, an LED, and the like. Generally, the light source 101 is any light emitter which emits coherent light. In some aspects of the present disclosure, the light source 101 may comprise multiple individual light emitters, each corresponding to a different wavelength or wavelength band. The light source 101 emits light in response to an image signal provided by the controller 112. The image signal includes image data corresponding to a plurality of frames to be successively displayed. Individual elements in the projection system 100, including but not limited to the DMD 105 and the projection optics 109, may be controlled by the controller 112. The image signal may originate from an external source in a streaming or cloud-based manner, may originate from an internal memory of the projection system 100 such as a hard disk, may originate from a removable medium that is operatively connected to the projection system 100, or combinations thereof.

Although FIG. 1 illustrates a generally linear optical path, in practice the optical path is generally more complex. For example, in the projection system 100, the second light 104 from the illumination optics 103 is steered to the DMD chip 105 (or chips) at a fixed angle, determined by the steering angle of the DMD mirrors, and then directed through the filter 107 to the projection optics 109. Moreover, while FIG. 1 illustrates the filter 107 as optically upstream from the projection optics 109, in practice the filter 107 may disposed at a location within the projection optics 109, as will be described in more detail below. The projection optics 109 includes one or more optical elements such as lenses, as will be described in more detail below. In some implementations, the Fourier aperture of the projection system 100 is located within the assembly housing the projection optics 109.

### Modular Projection Lens System

To accommodate for differences among theaters, a system and method may be provided to allow ready access to the Fourier aperture when setting up the projection system 100. Because the position of the aperture (and its size) depend on the wavelength of projection light, the illumination angle, and the tilt angle of the DMD 105, all of which may vary from projector to projector, access to the Fourier aperture may facilitate device calibration and adjustment. In some aspects, it is further possible to measure the contrast and/or efficiency of the image while these adjustments are made.

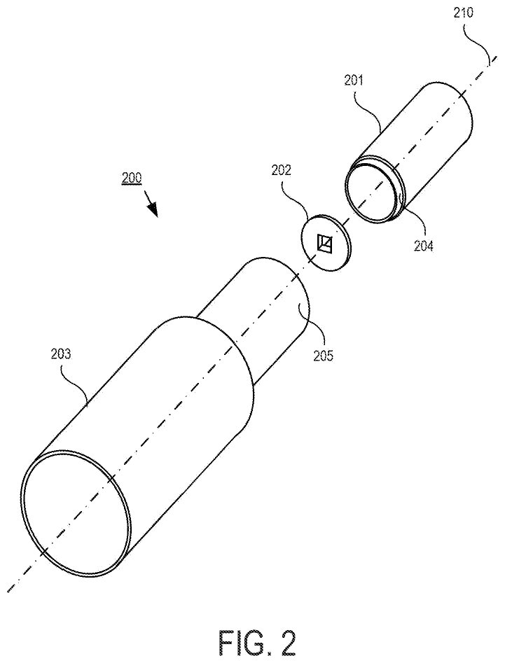

FIG. 2 is an exploded view an exemplary projection lens system 200 according to various aspects of the present disclosure. The projection lens system 200 is one example of the projection optics 109 illustrated in FIG. 1. To allow access to the Fourier aperture when setting up the projection system 100, the projection lens system 200 has a modular design. The projection lens system 200 includes a Fourier part 201 configured to form a Fourier transform of an object at an exit pupil thereof as will be described in more detail below (also referred to as a Fourier lens assembly), an aperture 202, and a zoom part 203 (also referred to as a zoom lens assembly). As used herein, “Fourier part” or “Fourier lens assembly” refers to an optical system that spatially Fourier transforms modulated light (e.g., light from the DMD 105) by focusing the modulated light onto a Fourier plane. The spatial Fourier transform imposed by the Fourier part 201 converts the propagation angle of each diffraction order of the modulated light to a corresponding spatial position on the Fourier plane. The Fourier part 201 thereby enables selection of desired diffraction orders, and rejection of undesired diffraction orders, by spatial filtering at the Fourier plane. The spatial Fourier transform of the modulated light at the Fourier plane is equivalent to a Fraunhofer diffraction pattern of the modulated light.

The Fourier part 201 includes a first attachment section 204, which may include threads, fasteners, and the like. The zoom part 203 includes a second attachment section 205, which may include complementary threads, fasteners, and the like to allow for mating with the first attachment section 204. In one example, the first attachment section 204 includes a male threaded portion and the second attachment section 205 includes a female threaded portion, or vice versa. In another example, the first attachment section 204 and the second attachment section 205 are configured for a friction fit, in which case one or more fastening elements such as screws, cams, flanges, and so on may be provided. In yet another example, the first attachment section 204 may include one or more radial pins and the second attachment section 205 may include a corresponding number of L-shaped slots, or vice versa, to thereby connect the Fourier part 201 and the zoom part 203 using a bayonet connection. By these examples, the Fourier part 201 may be removably attached to the zoom part 203 to provide a modular assembly as will be described in more detail below.

While FIG. 2 illustrates the Fourier part 201 and the zoom part 203 as being entirely separable, the present disclosure is not so limited. In some implementations, the Fourier part 201 and the zoom part 203 are only partially separable, for example by provided an access portion in one of the Fourier part 201 and the zoom part 203. The access portion may be a slot, a door, a window, and the like, such that an operator may access and/or swap the aperture 202 via the access portion. In such implementations, the Fourier part 201 and the zoom part 203 may be bonded (e.g., via an adhesive on the first attachment section 204 and/or the second attachment section 205) to prevent full separation. Alternatively, the Fourier part 201 and the zoom part 203 may be provided with an integral housing that includes the attachment portion.

The aperture 202 may be one example of the filter 107 illustrated in FIG. 1. The aperture 202 is configured to block a portion of light (e.g., modulated light corresponding to one or more diffraction orders) in the projection lens system 200. As illustrated in FIG. 2, the aperture 202 is a square opening having sides of, for example, 6 mm in length. FIG. 2 also illustrates an optical axis 210 of the projection lens system 200. When assembled, the Fourier part 201 and the zoom part 203 are substantially coaxial with one another and with the optical axis 210. In some implementations (for example, depending on the illumination angle), the aperture 202 is further substantially coaxial with the optical axis 210.

The projection lens system 200 may include or be associated with one or more non-optical elements, including a thermal dissipation device such as a heat sink (or cooling fins), one or more adhesives (or fasteners), and so on. In some implementations, the aperture 202 may block, and thus absorb, approximately 15% of incident light and therefore the heat sink or cooling fins may be positioned and configured so as to appropriately dissipate heat from the aperture 202. In some implementations, the aperture 202 is thermally isolated from other parts of the projection lens system 200.

The Fourier part 201 and the aperture 202 collectively operate as a Fourier lens with a spatial filter that may also be used as a fixed throw projection lens. The zoom part 203 illustrated in FIG. 2 may be one of a family of zoom lens assemblies configured to attach to the Fourier part 201, thereby to create the family of projection zoom lens systems and adapt to different theaters. In other words, the Fourier part 201 and the aperture 202 may be applicable to any theater setting, while the zoom part 203 provides a specific projection light pattern tailored to a particular theater. Therefore, by selecting a particular zoom part 203 from the family of zoom lens assemblies, and attaching the selected zoom part 203 to the Fourier part 201 and the aperture 202, a projection lens system 200 may be achieved which is adapted to the particular theater.

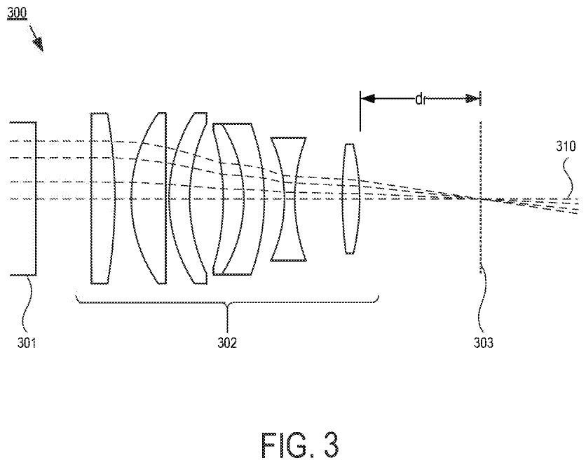

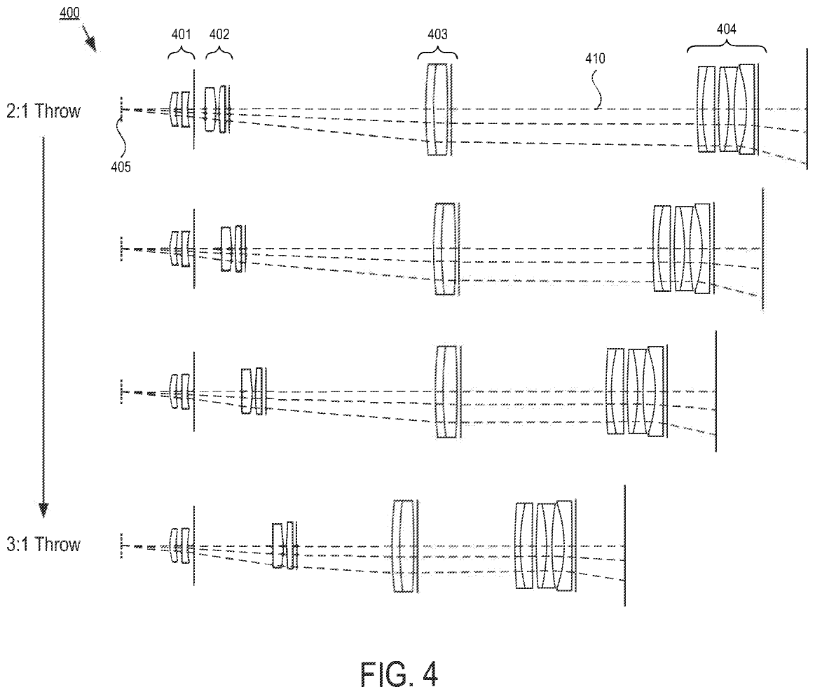

Both the Fourier part 201 and the zoom part 203 may include a plurality of individual lens elements. Exemplary configurations of lens elements for the Fourier part 201 and the zoom part 203 are illustrated in FIGS. 3 and 4, respectively.

FIG. 3 illustrates exemplary optics of an exemplary Fourier part 300 including a prism 301 (only a part of which is shown in FIG. 3) and a Fourier lens system 302 including a plurality of lenses (also referred to as lens elements). A Fourier plane 303 of the Fourier lens system 302 is also illustrated, as are exemplary light rays 310 to illustrate the optical behavior of the Fourier part 300. The Fourier lens system 302 may be contained within a housing of the Fourier part 201 illustrated in FIG. 2. In some examples, the prism 301 is also contained within the housing of the Fourier part 201; however, in other examples the prism 301 may be located optically upstream from the projection lens system 200 and optically downstream from the DMD 105. The Fourier plane 303 may approximately (e.g., within 10 mm) correspond to the location of the aperture 202.

The individual lens elements which make up the Fourier lens system 302 may be selected so as to create a low-distortion image at infinity, with the exit pupil at the Fourier plane 303. Reducing the aberrations of the Fourier lens system 302 may result in an increase in the ease of the design of the associated zoom portion or portions. The particular Fourier lens system 302 illustrated in FIG. 3 has less than 0.1% distortion.

The Fourier lens system 302 is telecentric; exhibits low wavefront error, thereby to minimize any effect on imaging of the Fourier plane 303; exhibits low lateral color; introduces low distortion; and includes an exit pupil (approximately coincident with the Fourier plane 303) a distance d_{f} from the nearest optical element, thereby to mitigate small area heat loads on the nearest optical element. As illustrated, the nearest optical element is the downstream surface of the final lens included in the Fourier lens system 302. The minimum magnitude of the distance d_{f} to sufficiently mitigate heat loads is dependent on parameters of the Fourier lens system 302, including the material type of the lenses in the Fourier lens system 302 and/or of the aperture 202 which will be located approximately at the Fourier plane 302. A magnitude of d_{f}>12 mm may be sufficient to mitigate small area heat loads; however, in some implementations the distance d_{f} is preferably approximately equal to (e.g., within 10% of) 40 mm.

The Fourier part 300 may include other optical elements in addition to the prism 301 and the Fourier lens system 302. In some examples, the Fourier part 300 may include one or more electronic crystals (e.g., a transmissive liquid crystal component that imparts deflection to light passing therethrough based on an applied voltage profile) or other deflecting elements, thereby to shift the projected image on the screen 111.

Moreover, the Fourier lens system 302 may be usable as a projection lens if re-focused, thereby to allow for adjustments to the Fourier aperture and/or the contrast of the projected image without requiring disassembly of the entire projection lens system 200, to facilitate calibration or defect detection, and so on.

In addition to its use as part of the projection lens system 200, the Fourier part 300 may have further applications as a result of its separability from the other elements in the projection lens system 200. Such further applications may include facilitating calibration or installation of the projection system 100. For example, the Fourier part 300 may be used as a standalone optical system to test the convergence and focus of DMDs, including but not limited to the DMD 105; to provide an initial look at potential image quality issues with elements of the projection system 100, including but not limited to the light source 101, the illumination optics 103, the DMD 105, and/or the prism 301; to facilitate sizing and positioning of the Fourier aperture 202; or to measure on/off contrast of the projection system 100. Alternatively, a simplified fixed lens may be attached to the Fourier part 300 for purposes of calibration, testing, defect detection, sizing and positioning, measurement, and so on.

FIG. 4 illustrates exemplary optics of an exemplary zoom part 400 in several zoom configurations. The zoom part 400 includes a fixed lens group 401, a first movable lens group 402, a second movable lens group 403, and a fourth movable lens group 404. A Fourier plane 405 is also illustrated, as are exemplary light rays 410 to illustrate the optical behavior of the zoom part 400. The lens groups illustrated in FIG. 4 may be contained within a housing of the zoom part 203 illustrated in FIG. 2. When the zoom part 400 is assembled together with the Fourier part 300, the Fourier plane 303 and the Fourier plane 405 may correspond to one another and may further be positioned approximately at the location of the aperture 202.

The zoom part 400 may include other optical elements in addition to the fixed lens group 401, the first movable lens group 402, the second movable lens group 403, and the third movable lens group 404. In some examples, the zoom part 400 may include an electronic crystal or other deflecting elements, thereby to shift the projected image on the screen 111.

The zoom part 400 acts in a manner similar to a telescope. That is, the object of the zoom part 400 is assumed to be near infinity, and the image side of the zoom part 400 is configured to create a real image at common screen distances (e.g., 10-30 m). The zoom part 400 illustrated in FIG. 4 is configured for a range of zoom configurations depending on the particular positions of the first movable lens group 402, the second movable lens group 403, and the third movable lens group 404. By appropriately moving the first movable lens group 402, the second movable lens group 403, and the third movable lens group 404 the throw ratio (i.e., the distance between the zoom part 400 and the screen 111, divided by the width of the screen 111) of the zoom part 400 may be changed. In the particular example illustrated in FIG. 4, the zoom part 400 is configured to provide a range of zoom configurations from a 2:1 throw ratio (top configuration) to a 3:1 throw ratio (bottom configuration) with an exemplary DMD. However, in practical implementations, the range of zoom configurations is not so limited. In some examples, the throw ratio may be between 1.2:1 and 4:1, inclusive.

In some implementations, the zoom part 400 is not configured for a range of zoom configurations but is instead provided with a fixed throw ratio. In such implementations, the first movable lens group 402, the second movable lens group 403, and the third movable lens group 404 of FIG. 4 may be replaced with corresponding fixed lens groups. For example, to provide a zoom part 400 with a fixed throw ratio of 2:1, the first movable lens group 402, the second movable lens group 403, and the third movable lens group 404 of the top configuration in FIG. 4 may be replaced with a second fixed lens group, a third fixed lens group, and a fourth fixed lens group, respectively. The fixed throw ratio may be between 1.2:1 and 4:1, inclusive. The zoom part 400 may still be referred to as a “zoom” part regardless of whether it includes movable lens groups to thereby provide a range of throw ratios or only fixed lens groups to thereby provide a fixed throw ratio.

Because the Fourier lens system 302 creates an image of the DMD (e.g., the DMD 105) at infinity (if placed such), the zoom part 400 operates as a zoom telescope. Moreover, the particular design of the lenses and lens groups in the zoom part 400 may be independent of the particular design of the Fourier lens system 302. The complexity of the zoom lens assembly is related to the degree of aberration correction effected. In some aspects of the present disclosure, the performance of the complete projection lens system 200 meets Digital Cinema Initiatives (DCI) image specifications; for example, the DCI Digital Cinema System Specification (DCSS) Version 1.3 or newer.

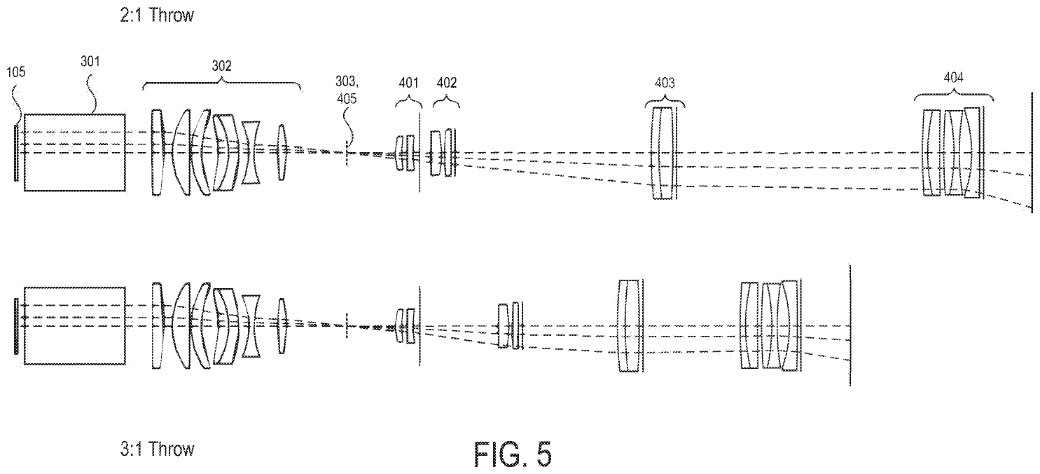

The Fourier part 300 and the zoom part 400 may be combined to achieve a complete lens system. FIG. 5 illustrates an exemplary assembled lens configuration according to such a combination. In FIG. 5, elements having the same reference numerals as described previously are indicated using the same reference numerals, and a detailed description thereof is not repeated here. FIG. 5 illustrates the assembled lens configuration where the zoom part 400 is in a 2:1 throw ratio configuration (top, corresponding to the top of FIG. 4) and where the zoom part 400 is in a 3:1 throw ratio configuration (bottom, corresponding to the bottom of FIG. 5).

The Fourier part 300 and the zoom part 400 are assembled such that the Fourier plane 303 of the Fourier part 300 and the Fourier plane 405 of the zoom part 400 are coplanar. Because the two parts are joined in collimated or substantially collimated optical space, the tolerance requirements to mate the two parts are loosened. For example, even in the event of a misalignment of the optical axes of the Fourier part 300 and the zoom part 400 (e.g., where one of the parts is shifted in a direction perpendicular to the optical axis) such that the aperture spot is displaced from the optical axis, there is likely to be no noticeable loss of image quality despite a potential shift of the projected image on the screen 111. In some examples, the Fourier part 300 and the zoom part 400 are considered to be substantially coaxial if the optical axes of the Fourier part 300 and the zoom part 400 are parallel and within 1 mm of each other.

Because the output of the Fourier part 300 and the input of the zoom part 400 are in collimated or substantially collimated optical space, the presence of dust on exposed lens surfaces in this region would not present an image artifact issue. If desired, flat windows could be placed at the output of the Fourier part 300 and input of the zoom part 400 to protect the respective lens elements therein. The flat windows could then be cleaned without completely disassembling the entire system.

In some implementations, the zoom part 400 further exhibits internal focus. Some comparative Digital Light Processing (DLP) Cinema lenses exhibit external focus, meaning that any lens mount must move in the direction along the optical axis (i.e., the z-axis) as well as in the two directions perpendicular to the optical axis (i.e., the x- and y-axes in a Cartesian coordinate system), for positioning of the projected image. In implementations where the zoom part 400 exhibits internal focus, there is no requirement for motion in the direction along the z-axis and therefore the projection lens system 200 may be more structurally sound and less complex. In comparison, the comparative DLP Cinema lenses which exhibit external focus may require the motors in the lens mount to move the complete lens system. The air space between the first doublet lens and the second doublet lens in the third movable lens group 404 may perform the focus function with a threaded focus assembly. In some examples, this mechanism may be motorized.

In some implementations, the zoom part 400 may be configured to compensate for errors and/or aberrations in the Fourier part 300, and vice versa. For example, if the amount of aberration introduced by one particular lens in the Fourier lens system 302 is known, then a particular lens in the fixed lens group 401 may be designed as to compensate for the aberration.

### Method of Providing Projection System

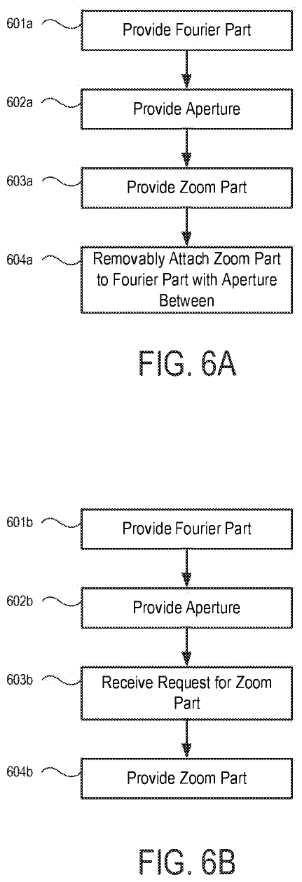

The individual optical elements of the projection may be manufactured by any known method. After the optical elements have been manufactured, they may be assembled at a production point or at a destination point. FIG. 6A illustrates an exemplary method of producing the projection lens system 200 at the production point, and FIG. 6B illustrates an exemplary method of producing the projection lens system 200 at the destination point.

In either method, the individual optical elements may be initially produced; for example, at a manufacturing facility. Thereafter, the optical elements may be appropriately assembled into the Fourier part 300 and the zoom part 400. In some implementations, a standardized Fourier part 300 may be utilized and, due to the modular nature of the projection lens system 200, paired as appropriate with one of a plurality (e.g., 10-12) of different zoom parts 400. After assembly, each of the Fourier part 300 and the zoom part 400 will include the corresponding attachment sections 204 and 205, as described above.

In the method of FIG. 6A, the projection lens system 200 may be provided as an assembly to the end-user. For example, a manufacturer or provider may first provide a Fourier part (such as the Fourier part 201 or the Fourier part 300) at operation 601a, provide an aperture (such as the aperture 202) at operation 602a, and provide a zoom part (such as the zoom part 203 or the zoom part 400) at operation 603a. At this point, the manufacturer or provider may assemble the projection lens system 200; for example, by removably attaching the zoom part to the Fourier part with the aperture between. Assembling the projection lens system 200 may further include calibrating the projection lens system 200. Subsequently, the assembled projection lens system 200 may be provided to the end-user.

In the method of FIG. 6B, the projection lens system 200 may be provided in a piecewise manner to the end-user. For example, a manufacturer or provider may first provide a Fourier part (such as the Fourier part 201 or the Fourier part 300) at operation 601b and provide an aperture (such as the aperture 202) at operation 602b. Because the manufacturer or provider may not know beforehand what zoom part would be most appropriate for the particular application (e.g., the particular theater) desired by the end-user, the manufacturer or provider may await, solicit, and/or receive a request for a particular zoom part (such as the zoom part 203 or the zoom part 400) from the end-user at operation 603b. In some examples, the request may not be for a particular zoom part, but may instead include one or more parameters (e.g., zoom part throw ratio, theater size, screen size, and so on). Thereafter, the manufacturer or provider may provide the appropriate zoom part to the end-user at operation 604b. The Fourier part and aperture may be provided to the end user at 601b and 602b in an assembled manner, for example with a default zoom part having a default removable attachment section. In such an example, providing the zoom part at 604b may include removing the default zoom part from the Fourier part and aperture, and replacing the default zoom part with the zoom part provided at 604b.

In some examples, the manufacturer or provider may further assemble the projection lens system 200; for example, by removably attaching the zoom part to the Fourier part with the aperture between. As above, assembling the projection lens system 200 may further include calibrating the projection lens system 200. Subsequently, the assembled projection lens system 200 may be provided to the end-user.

### Effects

The above projection systems and methods may provide for a configuration having a modular projection lens assembly in which a first optical part and a second optical part are removably attached to one another. Thereby, the above projection systems and methods may allow for access to the Fourier plane and for adaptability to a range of theater settings.

Systems, methods, and devices in accordance with the present disclosure may take any one or more of the following configurations.

(1) A projection lens system, comprising: a Fourier lens assembly including a first attachment section, the Fourier lens assembly configured to form a Fourier transform of an object at an exit pupil of the Fourier lens assembly; an aperture configured to block a portion of incident light, the aperture located approximately at a plane of the Fourier transform; and a zoom lens assembly including a second attachment section configured to be removably attached to the first attachment section.

(2) The projection lens system according to (1), wherein the first attachment section and the second attachment section are configured to mate by at least one of a thread, a fastener, a screw, a cam, a flange, a pin, or a slot.

(3) The projection lens system according to (1) or (2), wherein, in an assembled state, the Fourier lens assembly and the zoom lens assembly are substantially coaxial.

(4) The projection lens system according to any one of (1) to (3), wherein the Fourier lens assembly includes a plurality of lenses.

(5) The projection lens system according to (4), wherein a distance between the plane and a nearest lens surface of the plurality of lenses is greater than 12 mm.

(6) The projection lens system according to any one of (1) to (5), wherein the Fourier lens assembly includes an electronic crystal configured to shift a projection image in a direction perpendicular to an optical axis of the Fourier lens assembly.

(7) The projection lens system according to any one of (1) to (6), wherein the Fourier lens assembly is telecentric.

(8) The projection lens system according to any one of (1) to (7), wherein the Fourier lens assembly is configured to compensate for an aberration introduced by the zoom lens assembly.

(9) The projection lens system according to any one of (1) to (8), wherein the zoom lens assembly is configured to compensate for an aberration introduced by the Fourier lens assembly.

(10) The projection lens system according to any one of (1) to (9), further comprising a thermal dissipation device configured to dissipate heat from the aperture.

(11) The projection lens system according to any one of (1) to (10), wherein the aperture is thermally isolated from the Fourier lens assembly and the zoom lens assembly.

(12) The projection lens system according to any one of (1) to (11), wherein the zoom lens assembly exhibits internal focus.

(13) The projection lens system according to any one of (1) to (12), wherein the zoom lens assembly includes a fixed lens group and at least one movable lens group.

(14) The projection lens system according to any one of (1) to (13), wherein the zoom lens assembly includes a plurality of fixed lens groups.

(15) The projection lens system according to any one of (1) to (14), wherein the Fourier lens assembly includes a first flat window at an output of the Fourier lens assembly, and the zoom lens assembly includes a second flat window at an input of the zoom lens assembly.

(16) A method of providing a projection lens system, comprising: providing a Fourier lens assembly including a first attachment section, the Fourier lens assembly configured to form a Fourier transform of an object at an exit pupil of the Fourier lens assembly; disposing an aperture approximately at a plane of the Fourier transform, the aperture configured to block a portion of incident light; providing a first zoom lens assembly including a second attachment section; and removably attaching the second attachment section to the first attachment section.

(17) The method according to (16), further comprising: providing a second zoom lens assembly including a third attachment section; removing the second attachment section from the first attachment section; and removably attaching the third attachment section to the first attachment section.

(18) The method according to (16) or (17), wherein the first attachment section and the second attachment section are configured to mate by at least one of a thread, a fastener, a screw, a cam, a flange, a pin, or a slot.

(19) The method according to any one of (16) to (18), wherein the second attachment section and the first attachment section are removably attached in a manner such that the Fourier lens assembly and the first zoom lens assembly are substantially coaxial.

(20) The method according to any one of (16) to (19), further comprising: receiving a zoom lens assembly request; and providing the first zoom lens assembly in response to the zoom lens assembly request.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A projection lens system, comprising:
a Fourier lens assembly including a first attachment section, the Fourier lens assembly configured to form a Fourier transform of an object at a Fourier plane at an exit pupil of the Fourier lens assembly;
an aperture configured to block a portion of incident light, the aperture located approximately at the Fourier plane; and
a zoom lens assembly including a second attachment section configured to be removably attached to the first attachment section for providing access to the aperture.

2. The projection lens system of claim 1, wherein the Fourier plane is near the first attachment section.

3. The projection lens system according to claim 1, wherein the first attachment section and the second attachment section are configured to mate by at least one of a thread, a fastener, a screw, a cam, a flange, a pin, or a slot.

4. The projection lens system according to claim 1, wherein, in an assembled state, the Fourier lens assembly and the zoom lens assembly are substantially coaxial.

5. The projection lens system according to claim 1, wherein the Fourier lens assembly includes a plurality of lenses.

6. The projection lens system according to claim 5, wherein a distance between the Fourier plane and a nearest lens surface of the plurality of lenses is greater than 12 mm.

7. The projection lens system according to claim 1, wherein the Fourier lens assembly includes an electronic crystal configured to shift a projection image in a direction perpendicular to an optical axis of the Fourier lens assembly.

8. The projection lens system according to claim 1, wherein the Fourier lens assembly is telecentric.

9. The projection lens system according to claim 1, wherein the Fourier lens assembly is configured to compensate for an aberration introduced by the zoom lens assembly.

10. The projection lens system according to claim 1, wherein the zoom lens assembly is configured to compensate for an aberration introduced by the Fourier lens assembly.

11. The projection lens system according to claim 1, further comprising a thermal dissipation device configured to dissipate heat from the aperture.

12. The projection lens system according to claim 1, wherein the aperture is thermally isolated from the Fourier lens assembly and the zoom lens assembly.

13. The projection lens system according to claim 1, wherein the zoom lens assembly exhibits internal focus.

14. The projection lens system according to claim 1, wherein the zoom lens assembly includes a fixed lens group and at least one movable lens group.

15. The projection lens system according to claim 1, wherein the zoom lens assembly includes a plurality of fixed lens groups.

16. The projection lens system according to claim 1, wherein the Fourier lens assembly includes a first flat window at an output of the Fourier lens assembly, and the zoom lens assembly includes a second flat window at an input of the zoom lens assembly.

17. A method of providing a projection lens system, comprising:
providing a Fourier lens assembly including a first attachment section, the Fourier lens assembly configured to form a Fourier transform of an object at a Fourier plane at an exit pupil of the Fourier lens assembly;
disposing an aperture approximately at the Fourier plane, the aperture configured to block a portion of incident light;
providing a first zoom lens assembly including a second attachment section configured to be removably attached to the first attachment section for providing access to the aperture; and
removably attaching the second attachment section to the first attachment section.

18. The method according to claim 17, further comprising:
providing a second zoom lens assembly including a third attachment section;
removing the second attachment section from the first attachment section; and
removably attaching the third attachment section to the first attachment section.

19. The method according to claim 17, wherein the first attachment section and the second attachment section are configured to mate by at least one of a thread, a fastener, a screw, a cam, a flange, a pin, or a slot.

20. The method according to claim 17, wherein the second attachment section and the first attachment section are removably attached in a manner such that the Fourier lens assembly and the first zoom lens assembly are substantially coaxial.

21. The method according to claim 17, further comprising:
receiving a zoom lens assembly request; and
providing the first zoom lens assembly in response to the zoom lens assembly request.
